(19) United States
(12) Patent Application Publication
(10) Pub. No.: US 2015/0157929 A1
(43) Pub. Date: Jun. 11, 2015

(54) VIDEOGAME WITH E-COMMERCE TRANSACTION SUPPORT

(71) Applicant: Activision Publishing, Inc., Santa Monica, CA (US)

(72) Inventors: Gordon Hall, Doncaster (GB); Anthony Gowland, Edinburgh (GB)

(73) Assignee: Activision Publishing, Inc., Santa Monica, CA (US)

(21) Appl. No.: 14/103,785

(22) Filed: Dec. 11, 2013

(51) Int. Cl. A63F 13/30

(52) U.S. Cl. CPC A63F 13/12

(57) ABSTRACT

The present invention provides methods and system relating to videogames with improved e-commerce features. In some aspects of the invention, the improved e-commerce features include allowing players to purchase virtual goods from within gameplay without interrupting gameplay.

### BACKGROUND OF THE INVENTION

The present invention generally relates to e-commerce videogame related transactions, and more particularly to e-commerce transactions conducted during play of a videogame.

Videogames provide fun and enjoyment for many. Videogames allow users to participate in a variety of simulated activities. Videogames allow users to perform roles and experience activities that the users may not be able or desire to experience directly, whether due to cost, danger, or equipment concerns, or simply due to a role or activity being a fantasy.

With the advent of e-commerce, players have been provided with electronic purchasing opportunities related to play of videogames. Typically, these purchasing opportunities are presented outside of gameplay, for example, through a dedicated virtual store interface. Through such a virtual store interface, the player may browse a catalog of virtual goods and purchase one or more virtual goods, which are then “unlocked” in his or her inventory for future use during gameplay.

Providing purchasing opportunities from outside of gameplay, however, may not adequately allow game players the opportunity to purchase all of the virtual goods that the game player may find useful. In providing purchasing opportunities outside of gameplay, games are either paused or yet to start, and the player is removed from the action of gameplay. The player has time to browse and consider the various virtual goods for sale, and the player may buy items pre-emptively for anticipated use in games in the future. The player may not be able to fully anticipate future needs, and may not comprehend a particular desirability of purchasing various virtual items.

In some embodiments, “hot state selling” would provide purchasing opportunities to players close to or from with gameplay. The players may be asked to make purchasing decisions on the fly without interruption to gameplay. Hot state selling may require the player to make purchasing decisions during a core compulsion loop of gameplay, or a gameplay sequence that represents a core gameplay sequence of the videogame.

### SUMMARY OF THE INVENTION

One aspect of the invention provides a computer-implemented method of executing an online multiplayer gaming session, comprising: commencing the online multiplayer gaming session, said online multiplayer gaming session comprising a plurality of players in competition against each other in real-time gaming sequences; determining the occurrence of a predefined gameplay event; in response to the determining and without interruption to the online multiplayer gaming session, providing to a player an opportunity to purchase a virtual good, wherein the virtual good provides a primary benefit usable during the online multiplayer gameplay session and a secondary benefit usable in a subsequent online multiplayer gaming session, and wherein the virtual good is selected based at least in part on predefined gameplay event; receiving an indication that the player has requested to purchase the virtual good; and in response to receiving the indication that the player has requested to purchase the virtual good, activating the primary benefit.

These and other aspects of the invention are more fully comprehended upon review of this disclosure.

### BRIEF DESCRIPTION OF THE FIGURES

FIG. 1 is a block diagram illustrating an example of a system in accordance with aspects of the present invention.

FIG. 2 shows a flow chart for an illustrative process for conducting e-commerce transactions in videogames in accordance with aspects of the present invention.

FIG. 3 shows a flow chart for an illustrative process for conducting e-commerce transactions in videogames in accordance with aspects of the present invention.

FIG. 4 shows a flow chart for an illustrative process for conducting e-commerce transactions in videogames in accordance with aspects of the present invention.

FIG. 5 shows an illustrative in-game purchasing interface in the context of a first-person shooter videogame.

FIG. 6 is an example of a block diagram of a game device's processor and associated circuitry useful in accordance with aspects of the invention.

FIG. 7 is an example of a block diagram of a game server 700 useful in accordance with aspects of the invention.

### DETAILED DESCRIPTION

The present invention generally relates to conducting “hot state selling” e-commerce transactions in videogames. In some embodiments, “hot state selling” would provide purchasing opportunities to players close to or from with gameplay. The players may be asked to make purchasing decisions on the fly without interruption to gameplay. Hot state selling may require the player to make purchasing decisions during a core compulsion loop of gameplay, or a gameplay sequence that represents a core gameplay sequence of the videogame. In many embodiments the videogame is a real-time videogame. For example, a real-time videogame may be one in which the player controls a character or device in competition with competing characters or devices, controlled by other players or computer controlled, and activating of the competing characters or devices do not stop or hesitate while the player is engaged in purchasing of an item. Aspects of the invention relate to a videogame in which the player is presented a purchasing opportunity for a virtual good during a gameplay sequence that represents a core gameplay sequence of the videogame. In some embodiments the purchasing opportunity is presented during only a portion of the core gameplay sequence, and in some embodiments the portion is a time limited portion, for example a few or several seconds. The purchasing opportunity does not stop, pause, or otherwise interrupt gameplay. In various embodiments, the player is expected to make the purchasing decision on the fly. The player can purchase the virtual good with little, minimum, or no interruption to or distraction from gameplay, for example, by using a single button click or a voice command. The virtual good may then be automatically activated upon purchase and provides an immediate benefit or boost for the player. These and other aspects of the invention will be better understood in the context of the discussion herein.

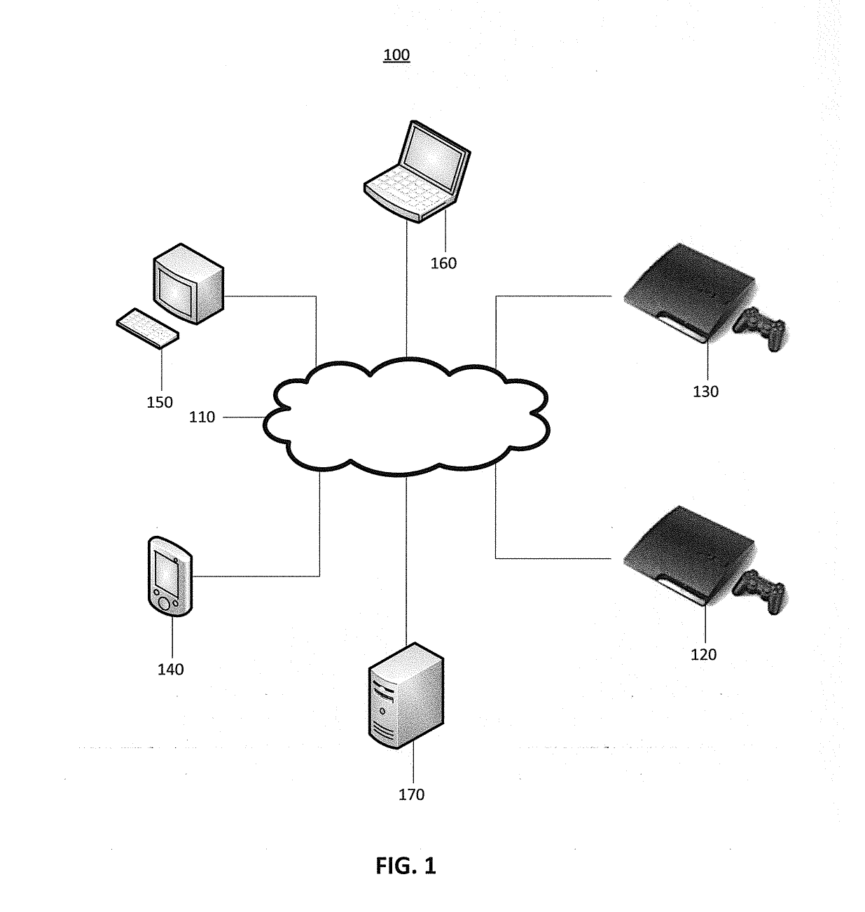

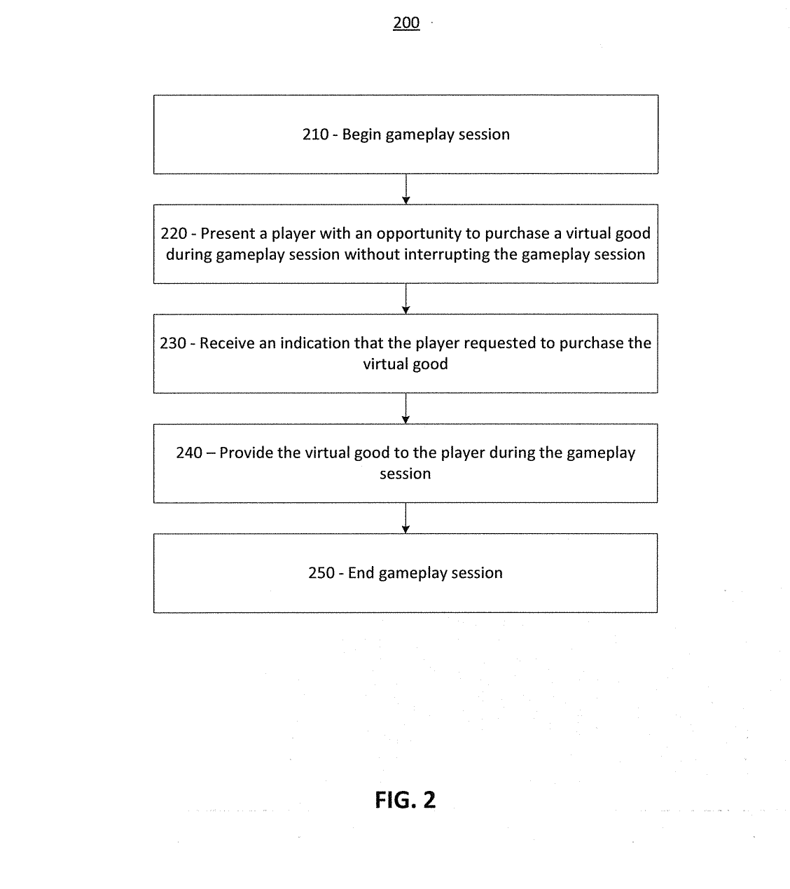

FIG. 2 shows a flow chart for an illustrative process 200 for conducting e-commerce transactions in videogames in accordance with aspects of the present invention. Although process 200 may be applied to a wide variety of videogames, the process is particularly suited for videogames that include core gameplay sequences that are played in real time (as opposed to, for example, turn-based games), such as first-person shooter (FPS) videogames, multiplayer online role-playing games (MORPG), multiplayer online battle arena (MOBA) videogames, real-time strategy videogames, sports videogames, music-based videogames, action videogames, combat and/or vehicle simulation videogames, and any other videogames with real-time core gameplay sequences. In videogames in which core gameplay sessions are played in real time, interruptions to gameplay are highly undesirable and even small breaks in gameplay can significantly detract from the player's experience. Process 200 provides for hot state selling of virtual goods during gameplay with minimal or no interruption to gameplay. Process 200 may be performed by one or more of the components of FIGS. 1, 6, and 7.

In block 210, the process begins execution of a gameplay session. In many embodiments, the gameplay session comprises a core gameplay sequence played in real time, such as in the videogame genres listed above. In a first-person shooter videogame, for example, the gameplay session may comprise a core gameplay sequence in which the player engages in real-time military combat or missions with computer-controlled non-player characters (NPCs) or with one or more other players, either competitively or in cooperation. Similarly, multiplayer online battle arena videogames or multiplayer online role-playing games may comprise core gameplay sequences in which the player engages in action or fantasy-based combat or missions NPCs or one or more other players, either competitively or in competition. Likewise, in sports videogames, the core gameplay sequence may pit the player in a real-time sporting competition with NPCs or with one or more other players, either competitively or in cooperation.

In block 220, the process presents a player with an opportunity to purchase a virtual good. The purchasing opportunity is presented from within the gameplay session without interrupting the gameplay session. For example, in some embodiments actions or activities of competing or cooperating characters are not modified due to the presentation of the opportunity to purchase a virtual good. In some embodiments game world effects on the player's character are also unimpeded by presentation of the opportunity. Virtual goods may comprise any number of virtual items and services depending on the type of game being played and/or context, including in-game items (e.g., weapons, armors, equipment, clothes, spells, abilities, vehicles, companions, etc.), bonuses and boosts (e.g., health boosts, mana boosts, ammunition boosts, damage boosts, speed boosts, aggression boosts, armor boosts, point bonuses, extra lives, experience bonuses, level bonuses, etc.), virtual currency, new levels, new game play modes, etc. By presenting the purchasing opportunity to the player from within a core gameplay sequence, the player may make a purchasing decision based on the player's current situation, for example, one that confers an in-game benefit to the player to improve the player's situation in the gameplay session (e.g., a bonus or boost to one of the player's character attributes, a new weapon or equipment, computer-controlled support or backup, extra lives, etc.).

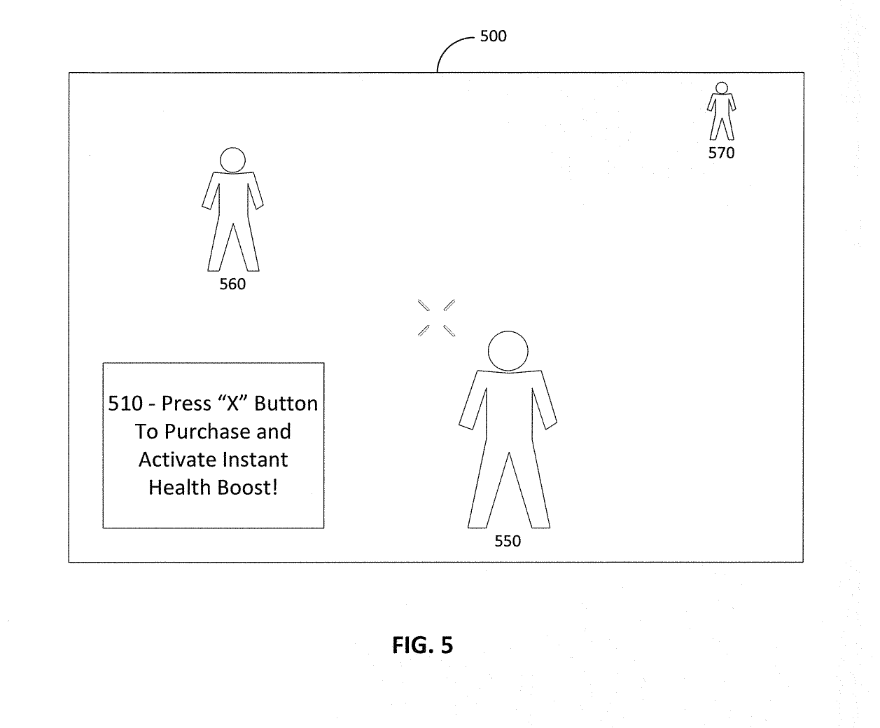

The purchasing opportunity is presented to the player through an in-game purchasing interface, which allows the player to execute e-commerce transactions during gameplay with minimal or no interruption to gameplay. FIG. 5 shows an illustrative in-game purchasing interface 500 in the context of a first-person shooter videogame. In the example of FIG. 5, the player is controlling an avatar in first-person combat against one or more enemies 550-570. The in-game purchasing interface presents one or more purchasing opportunities to the user through dialog box 510. In this particular example, the in-game purchasing interface is offering an instantaneous health boost to the player. The in-game purchasing interface presents the purchasing opportunities without stopping, pausing, or otherwise interrupting gameplay, and allows the player to complete a purchase with minimal effort, for example, through a single button click.

Although FIG. 5 shows the in-game purchasing interface as a dialog box, other interfaces may be used. For example, in some embodiments, one or more buttons or inputs may be mapped to purchase predefined virtual goods. Because the player knows in advance the purchasing functions of the one or more buttons or inputs, in such embodiments, a visual indication of the purchasing opportunity may not be needed. In other embodiments, an audio indication may alert the player of a purchasing opportunity. In other embodiments, the purchasing opportunity may offer a plurality of goods for purchase. In such embodiments, different buttons may be mapped to purchase different goods to facilitate purchases with minimal distraction from gameplay. In other embodiments, the player's game device may receive as input voice commands from the player, which may be used to complete the purchase. In yet other embodiments, the player's game device may receive as input information representing the player's gestures or body positions, which may be used to complete the purchase.

Referring back to FIG. 2, in block 230, the process receives an indication that the player requested to purchase the virtual good. As suggested above, the process allows the player to request purchase of the virtual good with minimum distraction from gameplay, for example, with a single button click, voice command, or player gesture. In some embodiments, the player's financial information (e.g., information necessary to facilitate a credit card transaction) is collected before the gameplay session begins and associated with an account of the player. Additionally or alternatively, the player may be billed for the virtual good after the gameplay session completes. In some embodiments, the process provides an audiovisual cue (e.g., a sound effect and/or visual effect) in response to the player requesting to purchase the good.

In block 240, the process provides the virtual good to the player for use in the current gameplay session. In some embodiments, the virtual good is provided immediately in response to receiving an indication that the player requested to purchase the virtual good. In some embodiments, the virtual good provides an in-game benefit to the player improving the player's situation within the game. In some embodiments, the virtual good may be activated by the player some time after the process provides the virtual good to the player (e.g., the player may store a health boost in his inventory for later use). Alternately or additionally, the process may instantaneously and automatically activate the virtual good when the virtual good is provided to the user. In such embodiments, the player perceives requesting to purchase the virtual good, receiving the virtual good, and activating the virtual good as a single atomic action.

In block 250, the process ends the gameplay session.

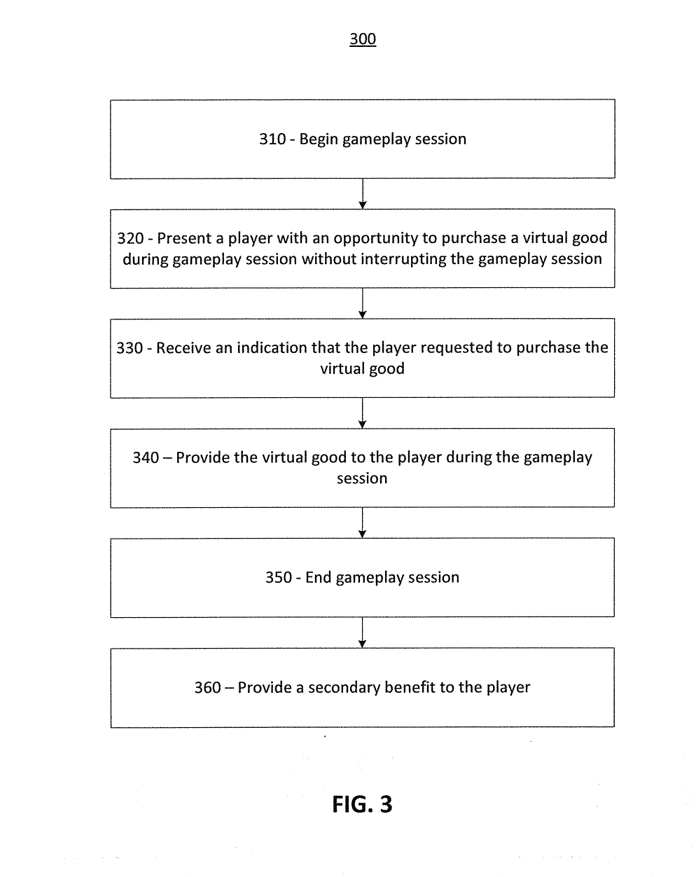

FIG. 3 shows a flow chart for an illustrative process 300 for conducting e-commerce transactions in videogames in accordance with aspects of the present invention. As with process 200 of FIG. 2, process 300 may be applied to a wide variety of videogames, but is particularly suited for videogames that include core gameplay sequences that are played in real time. Process 300 provides for purchases of virtual goods during gameplay with minimal or no interruption to gameplay. Process 300 further provides for virtual goods that have a primary benefit and secondary benefit, as discussed in more detail below. Process 300 may be performed by one or more of the components of FIGS. 1, 6, and 7.

In block 310, the process beings execution of a gameplay session. As discussed in connection with the process of FIG. 2, in some embodiments, the gameplay session comprises core gameplay sequences that are played in real time.

In block 320, the process presents a player with an opportunity to purchase a virtual good. The presentation of purchasing opportunity is similar to the one described in connection with FIG. 2. As with the process of FIG. 2, the purchasing opportunity is presented from within the gameplay session without interruption to the gameplay session. Further, in some embodiments, the process further incentivizes the player to purchase the offered virtual good, for example, by offering a virtual good that confers an in-game benefit to the player to improve the player's situation in the gameplay session.

In block 330, the process receives an indication that the player requested to purchase the virtual good (similar to the process of FIG. 2). As discussed in connection with the process of FIG. 2, the process allows the player to request purchase of the virtual good with minimum distraction from gameplay, for example, with a single button click or the player's voice commands or gestures. In some embodiments, the player's financial information (e.g., information necessary to facilitate a credit card transaction) collected before the gameplay session begins and associated with an account of the player.

In block 340, the process provides the virtual good to the player for use in the current gameplay session (similar to the process of FIG. 2). The virtual good of process 300 provides a primary in-game benefit to the player that improves the player's situation within the game. As with the process of FIG. 2, in some embodiments, the primary in-game benefit may be activated automatically when the player receives the virtual good. Alternatively of additionally, the virtual good may be stored by the player and the player may manually activate the primary in-game benefit at a later time.

In block 350, the process ends the gameplay session.

In block 360, the process provides a secondary benefit to the player. The secondary benefit may be any of a variety of items, including in-game virtual goods or virtual goods to be used outside of gameplay (e.g., virtual currency for use in online stores, bonus levels, bonus gameplay modes, etc.). In some embodiments, the secondary benefits may be a permanent increase to the player's attributes. In some embodiments, the secondary benefit may comprise real-world goods, like clothing, toys, peripherals, trading cards, or other souvenirs related to the videogame. In embodiments where the primary in-game benefit of the virtual good is non-permanent, the player may feel dissatisfaction or remorse for purchasing the virtual good at the completion of gameplay. Granting a secondary benefit, which may or may not be permanent, helps alleviate such dissatisfaction or remorse.

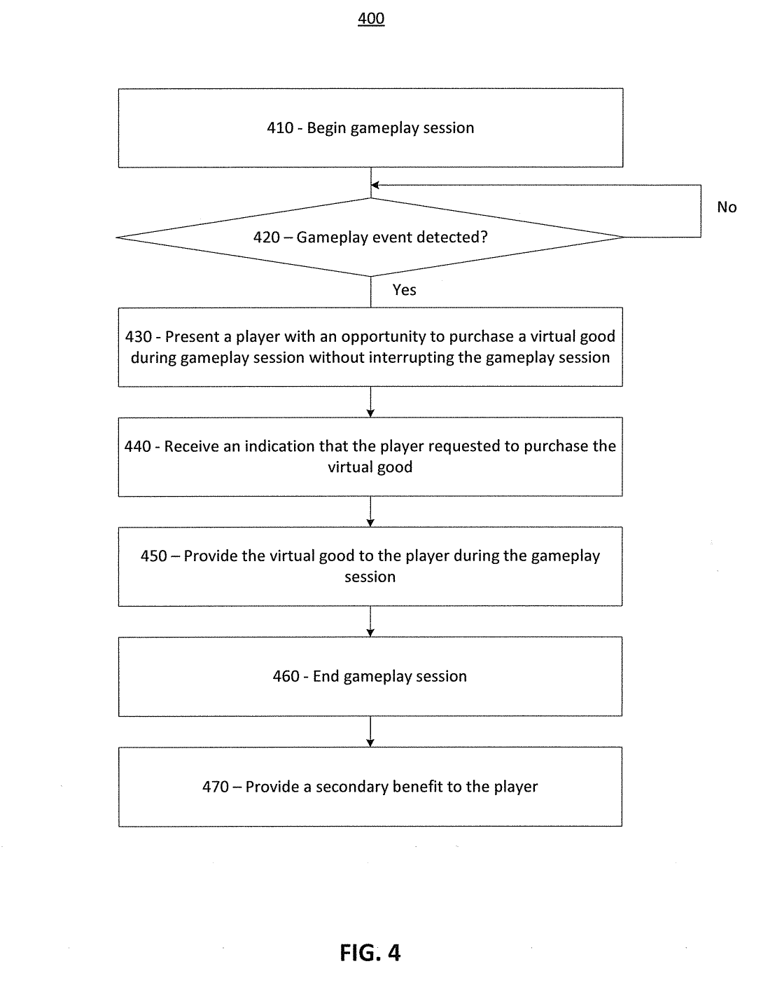

FIG. 4 shows a flow chart for an illustrative process 400 for conducting e-commerce transactions in videogames in accordance with aspects of the present invention. As with the processes of FIGS. 2 and 3, process 400 may be applied to a wide variety of videogames, but is particularly suited for videogames that include core gameplay sequences that are played in real time. Process 400 provides for purchases of virtual goods during gameplay with minimal or no interruption to gameplay. Process 400 further provides for virtual goods that have a primary benefit and secondary benefit, as discussed in more detail below. Process 400 may be performed by one or more of the components of FIGS. 1, 6, and 7.

In block 410, the process beings execution of a gameplay session. As discussed in connection with the process of FIG. 2, in some embodiments, the gameplay session comprises core gameplay sequences that are played in real time.

In block 420, the process determines whether a predefined gameplay event was detected. The predefined gameplay event may be any number of gameplay events. For example, in some embodiments, the gameplay event may relate to player performance or attributes (e.g., player reaching a certain threshold level of health or energy, player sustaining a certain amount of damage in a particular period of time, player attaining a certain number of kills in a combat game, player completing certain gameplay objectives, player reaching a certain threshold level of ammunition or armor, etc.). Additionally or alternatively, and still by way of example, the gameplay event may relate to the player's opponents (e.g., number of opponents in vicinity of player, opponent reaching a certain threshold level of health, energy, ammunition, armor, etc.). If the process detects the predefined gameplay event, the process proceeds to block 430.

In block 430, the process presents a player with an opportunity to purchase a virtual good in response to detecting the predefined gameplay event. The presentation of purchasing opportunity is similar to the one described in connection with FIG. 2. As with the process of FIG. 2, the purchasing opportunity is presented from within the gameplay session without interruption to the gameplay session. Further, in some embodiments, the process further incentivizes the player to purchase the offered virtual good, for example, by offering a virtual good that confers an in-game benefit to the player to improve the player's situation in the gameplay session. In many embodiments, the virtual good presented relates to the predefined gameplay event. For example, if the predefined gameplay event is the player's health reaching a certain threshold level (e.g., 25% or less), the virtual good offered for purchase may be a health pack. In another example, if the gameplay event is the player being killed in a combat game, the virtual good may be an extra life or, in games where the player must wait a certain amount of time before respawning, the virtual good may shorter or eliminate the waiting time for respawning. As another example, the process may present a purchasing opportunity to boost the player's weapon damage or accuracy when the player encounters an enemy with a more powerful weapon than the player or an enemy who is a high level than the player. These examples of purchasing opportunities responsive to gameplay events are, of course, exemplary, and any number of purchasing opportunities may be presented in response to any number of gameplay events.

In block 440, the process receives an indication that the player requested to purchase the virtual good (similar to the process of FIG. 2). As discussed in connection with the process of FIG. 2, the process allows the player to request purchase of the virtual good with minimum distraction from gameplay, for example, with a single button click or the player's voice commands or gestures. In some embodiments, the player's financial information (e.g., information necessary to facilitate a credit card transaction) collected before the gameplay session begins and associated with an account of the player.

In block 450, the process provides the virtual good to the player for use in the current gameplay session (similar to the process of FIG. 2). The virtual good of process 400 provides a primary in-game benefit to the player that improves the player's situation within the game. As with the process of FIG. 2, in some embodiments, the primary in-game benefit may be activated automatically when the player receives the virtual good. Alternatively of additionally, the virtual good may be stored by the player and the player may manually activate the primary in-game benefit at a later time.

In block 460, the process ends the gameplay session.

In optional block 470, the process provides a secondary benefit to the player. As with the process of FIG. 3, the secondary benefit may be any of a variety of items, including in-game virtual goods or virtual goods to be used outside of gameplay (e.g., virtual currency for use in online stores, bonus levels, bonus gameplay modes, etc.). In some embodiments, the secondary benefits may be a permanent increase to the player's attributes. In some embodiments, the secondary benefit may comprise real-world goods, like clothing, toys, peripherals, trading cards, or other souvenirs related to the videogame. In embodiments where the primary in-game benefit of the virtual good is non-permanent, the player may feel dissatisfaction or remorse for purchasing the virtual good at the completion of gameplay. Granting a secondary benefit, which may or may not be permanent, helps alleviate such dissatisfaction or remorse.

FIG. 1 is a block diagram illustrating an exemplary system 100 in accordance with aspects of the present invention. System 100 includes a communication network 110, which may be the Internet, for example. System 100 also includes game devices 120-160 and game server 170. Game devices 120-160 may comprise various compute devices suitable for executing videogames and communicating over communication network 110. In this example, system 100 comprises a first videogame console 120 and a second videogame console 130. System 100 further comprises game devices such as, for example, smartphone 140, desktop computer 150, and laptop computer 160. The game devices 120-160 each have one or more processors, memory, communication circuitry, and associated hardware. Game devices 120-160 may communicate with other game devices 120-160 and/or components of system 100 by sending and receiving data through communication network 110. Of course, the number of devices shown in FIG. 1 is merely exemplary, and in many embodiments, many more devices may be present.

During gameplay the game devices 120-160 execute program instructions to provide for play of the videogame. Videogame players provide gameplay inputs using their respective input devices, for example touchscreens, game controllers, keyboards, mice, etc., and the associated displays and monitors display gameplay events.

Game server 170 provides function related to the online distribution, operation, and hosting of videogames. In some embodiments, game server 170 may host and/or operate one or more videogames such that players may connect to game server 170 to play the one or more videogames online. In some embodiments, game server 170 may distribute one or more videogames by, for example, making the one or more videogames available for download to player computers 120-160. In some embodiments, game server 170 may host one or more instances of multiplayer online videogames, or coordinate the hosting of such games, and allow a plurality of players to join and participate in the multiplayer online videogame.

Game server 170 may comprise an e-commerce module that provides an online store for purchasing goods and services. Virtual goods may comprise any number of goods, including in-game items (e.g., weapons, armors, equipment, clothes, spells, abilities, vehicles, companions, etc.), bonuses and boosts (e.g., health boosts, mana boots, ammunition boosts, damage boosts, speed boosts, aggression boosts, armor boosts, point bonuses, experience bonuses, level bonuses, etc.), virtual currency, new characters, new levels, new game play modes, etc.

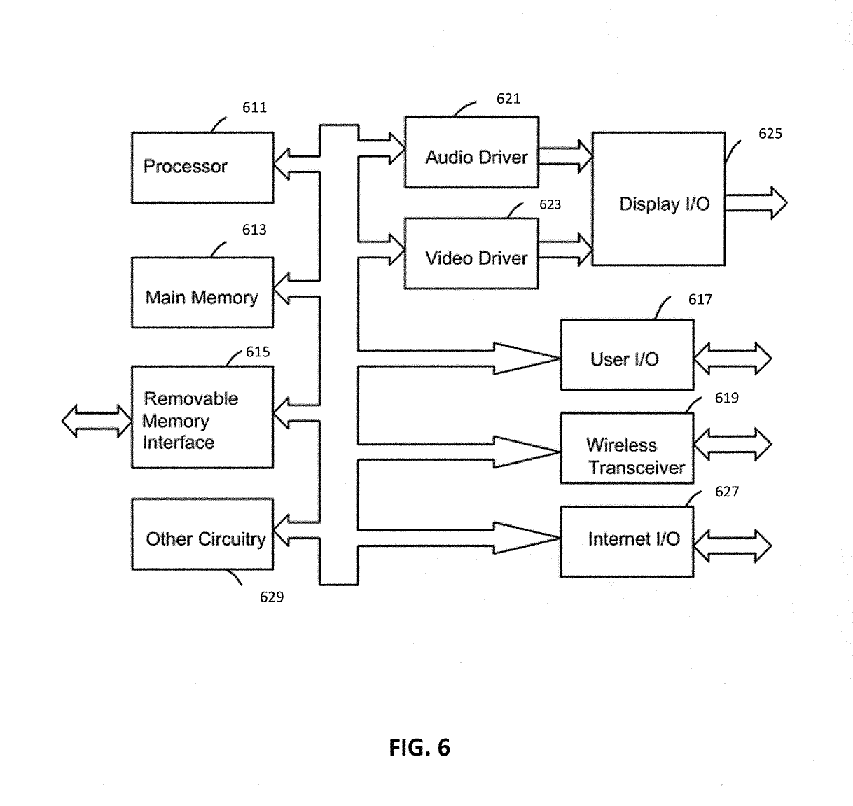

FIG. 6 is an example of a block diagram of a game device's processor and associated circuitry useful in accordance with aspects of the invention. As shown in FIG. 6, a processor 611 is connected to other components via a bus. The other components include a main memory 613 and a memory interface 615, generally coupled to a memory device, which may be a removable memory device, for example, a CD-ROM, DVD-ROM, or Blu-ray disc drive. The processor may execute instructions retrieved from the removable memory device or some other memory device to control gameplay and store game state information in the main memory. For example, the instructions may be for determining possible movements, positions, and locations of a game character.

The processor is coupled to an audio driver 621 and a video driver 623. The audio driver produces sound signals and the video driver produces image signals. The sound signals and image signals are transmitted from the game console via a display I/O device 625. The display I/O device generally supplies the sound and image signals to a display device external to the game console. Sound signals may also be supplied to a peripheral device such as a toy reader.

The processor may also be coupled to a user I/O device 617, a wireless transceiver 619, an Internet I/O device 627, and other circuitry 629. The user I/O device may receive signals from a peripheral device and/or signals from a keyboard, a mouse, and/or a game controller, with generally the keyboard, mouse, and/or controller being used by a user and providing user inputs, for example, during gameplay. Alternatively or additionally, the game console may receive user inputs via the wireless transceiver. The Internet I/O device provides a communication channel that may be used, for example, for multiple player games.

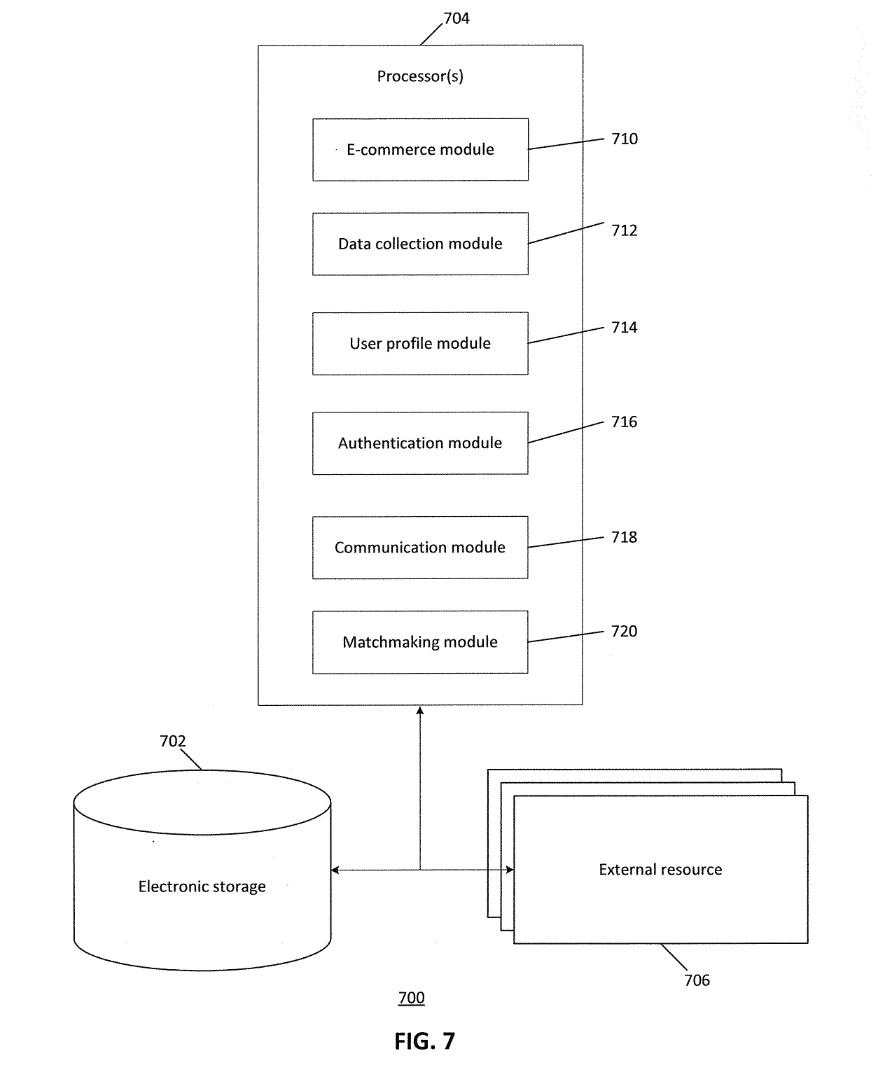

FIG. 7 is an example of a block diagram of a game server 700 useful in accordance with aspects of the invention. Game server 700 is coupled to a network (not explicitly shown), for example the Internet. In some implementations, game server 700 may comprise one or more of electronic storage 702, processor(s) 704, external resources 706, and/or other components. The various components of game server 700 may be configured for electronic communication among one another. Such communication may be accomplished via one or more networks, one or more direct connections, one or more wireless connections, one or more wired connections, and/or other electronic communication media. Game server 700 may be in communication with game devices and other client computing platforms using a client/server architecture.

Processor(s) 704 may be configured to provide information processing capabilities within game server 700. For example, processor(s) 704 may configured to execute computer program modules that may include one or more of an e-commerce module 710, a data collection module 712, a user profile module 714, an authentication module 716, a communication module 718, a matchmaking module 720, and/or other modules. In various embodiments, these modules may perform various operations as further discussed herein.

In some embodiments, e-commerce module 710 performs operations relating to conducting e-commerce transactions. For example, e-commerce module 710 may host one or more storefronts or purchasing interfaces. E-commerce module 710 may further comprise databases that store virtual goods and/or services available for purchase. The databases may contain the details about the various goods and/or services that can be listed in one or more storefronts or purchasing interfaces, including pricing information, a description of the goods and/or services, fulfillment details, etc. The process of conducting e-commerce transactions in the context of videogames is discussed further herein, for example in connection with FIGS. 2, 3, and 4.

In some embodiments, data collection module 712 performs operations relating to the collection of game-related information regarding e-commerce transactions, potential host systems, player data, social networks, game data, and network connection quality indicators. In some embodiments, player profile module 714 receives and/or determines user information, for example player financial information, player skill levels, game system game capabilities, gaming preferences, and other player-related information. In some embodiments, authentication module 716 performs operations relating to authentication of players and potential hosts. In some embodiments, communications module 718 performs operations relating to communication with storage and/or external resources, as well as communicating over a network, for example the Internet. In some embodiments, matchmaking module 720 performs operations relating to matching player game systems with host game systems for multiplayer video gaming sessions.

In some implementations, electronic storage 702 may include information about prior purchases, virtual goods and/or services, available games, user profile data, social networking data, data collected from previous gameplay and matchmaking sessions, and/or other data. In some implementations, electronic storage 702 may comprise non-transitory electronic storage media that electronically stores information. Electronic storage 702 may include one or both of system storage that is provided integrally (e.g., substantially non-removable) with game server 700 and/or removable storage that is removably connectable to game server 700 via, for example, a port (e.g., a USB port, a firewire port, etc.) or a drive (e.g., a disk drive, etc.). Electronic storage 702 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 702 may include virtual storage resources, such as storage resources provided via a cloud and/or a virtual private network. Electronic storage 702 may store software algorithms, information determined by processor 704, information received via client computing platforms, and/or other information that enables game server 700 to function properly. Electronic storage 702 may be a separate component within game server 700, or electronic storage 702 may be provided integrally with one or more other components of game server 700. For example, in certain implementations, the non-transitory electronic storage media of electronic storage 702 may include a cache (e.g., L1 cache, L2 cache, etc.) of processor 704.

In some implementations, electronic storage 702, processor(s) 704, external resources 706, and/or other components (e.g., additional instances of game servers) may be operatively linked via one or more electronic communication links. For example, such electronic communication links may be established, at least in part, via a network such as the internet and/or other networks. It will be appreciated that this is not intended to be limiting, and that the scope of this disclosure includes implementations in which electronic storage 702, processor(s) 704, external resources 706, and/or other components may be operatively linked via some other communication media.

In some implementations, the external resources 706 may include services and information sources external to game server 700, for example, third-party social networking services, third-party merchandising databases and catalogs, web hosting services, game server services, media streaming services, etc. In some implementations, some or all of the functionality attributed herein to external resources 706 may be provided by resources included in game server 700.

In some implementations, processor(s) 704 may include one or more of a digital processor, an analog processor, a digital circuit designed to process information, an analog circuit designed to process information, a state machine, and/or other mechanisms for electronically processing information. Although processor(s) 704 is shown in FIG. 7 as a single entity, this is for illustrative purposes only. In some implementations, processor(s) 704 may include a plurality of processing units. These processing units may be physically located within the same device, or processor(s) 704 may represent processing functionality of a plurality of distributed devices operating in coordination.

Processor(s) 704 may be configured to execute e-commerce module 710, data collection module 712, user profile module 714, authentication module 716, communication module 718, matchmaking module 720, and/or other modules. Processor(s) 704 may be configured to execute modules 710, 712, 714, 716, 718, 720, and/or other modules by software; hardware; firmware; some combination of software, hardware, and/or firmware; and/or other mechanisms for configuring processing capabilities on processor(s) 704.

It should be appreciated that although modules 710, 712, 714, 716, 718, and 720 are illustrated in FIG. 7 as being co-located within a single processing unit, in implementations in which processor(s) 304 includes multiple processing units, one or more of modules 710, 712, 714, 716, 718, and 720 may be located remotely from the other modules. The description of the functionality provided by the different modules 710, 712, 714, 716, 718, and 720 provided below is for illustrative purposes, and is not intended to be limiting, as any of modules 710, 712, 714, 716, 718, and 720 may provide more or less functionality than is described. For example, one or more of modules 710, 712, 714, 716, 718, and 720 may be eliminated, and some or all of its functionality may be provided by other ones of modules 710, 712, 714, 716, 718, and 720. As another example, processor 704 may be configured to execute one or more additional modules that may perform some or all of the functionality attributed below to one of modules 710, 712, 714, 716, 718, and 720.

Although the invention has been discussed with respect to various embodiments, it should be recognized that the invention comprises the novel and non-obvious claims supported by this disclosure.

What is claimed:

1. A computer-implemented method of executing an online multiplayer gaming session, comprising:
commencing the online multiplayer gaming session, said online multiplayer gaming session comprising a plurality of players in competition against each other in real-time gaming sequences;
determining the occurrence of a predefined gameplay event;
in response to the determining and without interruption to the online multiplayer gaming session, providing to a player an opportunity to purchase a virtual good, wherein the virtual good provides a primary benefit usable during the online multiplayer gameplay session and a secondary benefit usable in a subsequent online multiplayer gaming session, and wherein the virtual good is selected based at least in part on predefined gameplay event;
receiving an indication that the player has requested to purchase the virtual good; and
in response to receiving the indication that the player has requested to purchase the virtual good, activating the primary benefit.

2. The method of claim 1, wherein the player requests to purchase the virtual good using a single button click.

3. The method of claim 1, wherein the player requests to purchase the virtual good using a voice command.

4. The method of claim 1, further comprising providing an audiovisual cue in response to activating the primary benefit.

5. The method of claim 1, wherein the predefined gameplay event is the player's virtual character's health reaching a threshold level.

6. The method of claim 1, wherein the primary benefit is one of a health bonus or an armor bonus.

7. The method of claim 1, wherein the predefined gameplay event is the death of the player's virtual character.

8. The method of claim 1, wherein the primary benefit reduces the respawn time of the player's virtual character.

9. The method of claim 1, wherein the secondary benefit is a permanent increase to at least one of the player's virtual character's attributes.

10. A computer-implemented method useful in provision of videogame play, comprising:
presenting a real-time gameplay sequence in a session of play of a videogame to a player controlling a character engaged in the gameplay sequence;
during presentation of the gameplay sequence, and without delaying course of execution of the gameplay sequence, presenting an opportunity to purchase a virtual good to the player, the virtual good being helpful to the character during the gameplay sequence;
during presentation of the gameplay sequence, and without delaying course of execution of the gameplay sequence, receiving a request to purchase the virtual good; and
during presentation of the gameplay sequence, activating the virtual good for use.

11. The method of claim 10, wherein the virtual good has at least a component available to and helpful to the character in a further session of play of the videogame.

12. The method of claim 10, wherein the videogame is a first person shooter videogame.
